(19) United States
(12) Patent Application Publication
(10) Pub. No.: US 2010/0083906 A1
(43) Pub. Date: Apr. 8, 2010

(54) Easy Empty Trough

(76) Inventor: Richard Howard Barton, Red Oak, TX (US)

Correspondence Address: Richard H. Barton, 305 Methodist Road, Red Oak, TX, 75154, US

(21) Appl. No.: 12/211,671

(22) Filed: Oct. 8, 2008

(51) Int. Cl. A01K 1/10; A01K 5/01; A01K 7/00

(52) U.S. Cl. 119/61.4; 119/61.1; 119/72

(57) ABSTRACT

This invention is directed to troughs and more particularly to pre-cast or molded troughs made of plastic, fiberglass or other appropriate material and utilizing a novel shape whereby the trough rests on it's natural tipping point using a novel pair of stabilizers made to rest on the ground and fit into corresponding cavities on the underside of the trough to maintain an upright and stable position until tipping is desired. The unique shape makes possible the slight backward tipping of the trough, done easily by one person, so the stabilizers can be kicked away and the trough tipped forward to empty, clean and/or refill.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING

Not Applicable

### BACKGROUND OF THE INVENTION

This invention relates generally to troughs used to feed and water livestock and includes any use of a trough that would hold enough material or material dense enough to cause the trough to be too heavy for one individual to easily empty for the purpose of cleaning, refilling or both.

### BRIEF SUMMARY OF THE INVENTION

Troughs used for feeding, watering or storing material are vulnerable to a wide variety of elements that cause the contents to become unhealthy or unusable. Unwanted creatures such as mosquitoes and rats and undesirable weather conditions like snow, ice, and heat contaminate and damage the contents of troughs that are not kept clean.

The density and/or the quantity of the material stored in the trough cause troughs of the past to be too heavy for one individual to easily empty for cleaning, refilling or both. Because of the cost and inconvenience of needing two people to empty troughs of the past, troughs have not been kept clean and Livestock have been at risk for disease.

The present invention asserts that one person can achieve maintaining clean water and therefore maintaining clean water will be a less neglected task and less expensive task.

Cleaner water will produce healthier more productive livestock and materials stored in troughs will be less vulnerable to harmful elements.

### DESCRIPTION OF DRAWINGS ON SHEETS 1 THROUGH 3

FIG. 1 is looking down into the trough

FIG. 2 is looking at the trough from the front

FIG. 3 is a side view of the kickout stabilizer

FIG. 4 is a figure simulating the water line

FIG. 5 is a side view of the trough with kickout stabilizer in stabilizing position

FIG. 6 is a side view of the trough tipped slightly toward the back so stabilizers can be kicked out

FIG. 7 is a side view of the trough with kickout stabilizer in kicked out position, trough ready to tip

FIG. 8 is a side view of the trough resting on its natural tipping point

FIG. 9 is a side view of the trough in partially tipped to empty position

FIG. 10 is a side view of the trough in increased tipping position 1

FIG. 11 is the trough completely tipped for emptying and/or cleaning

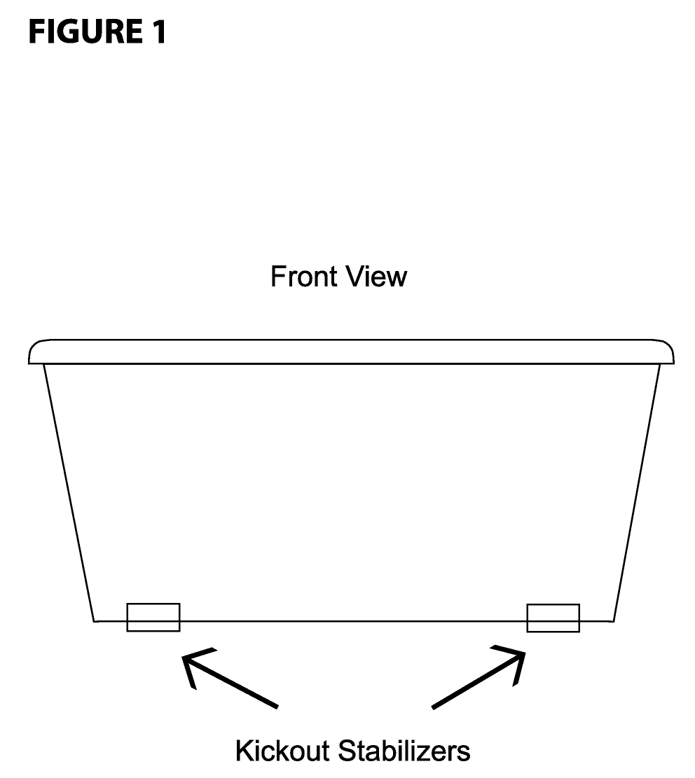

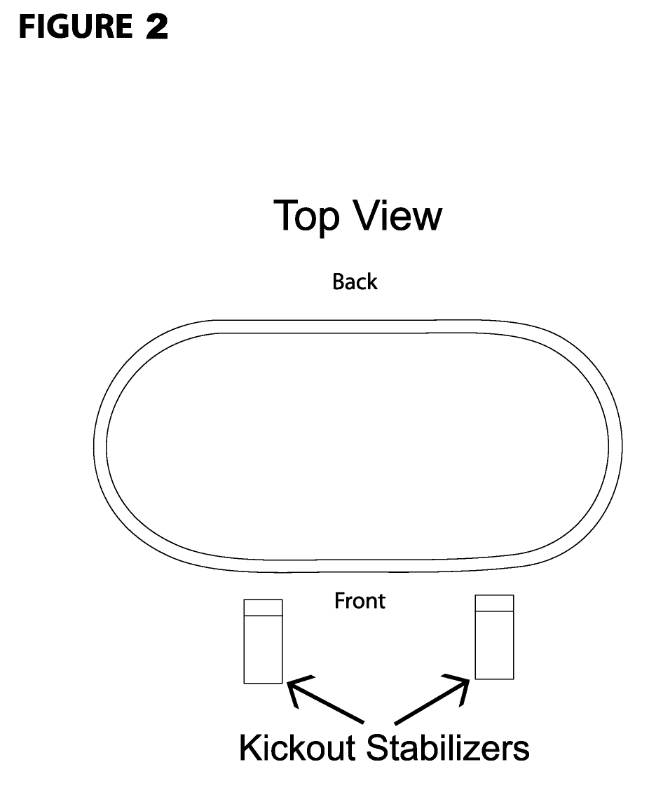

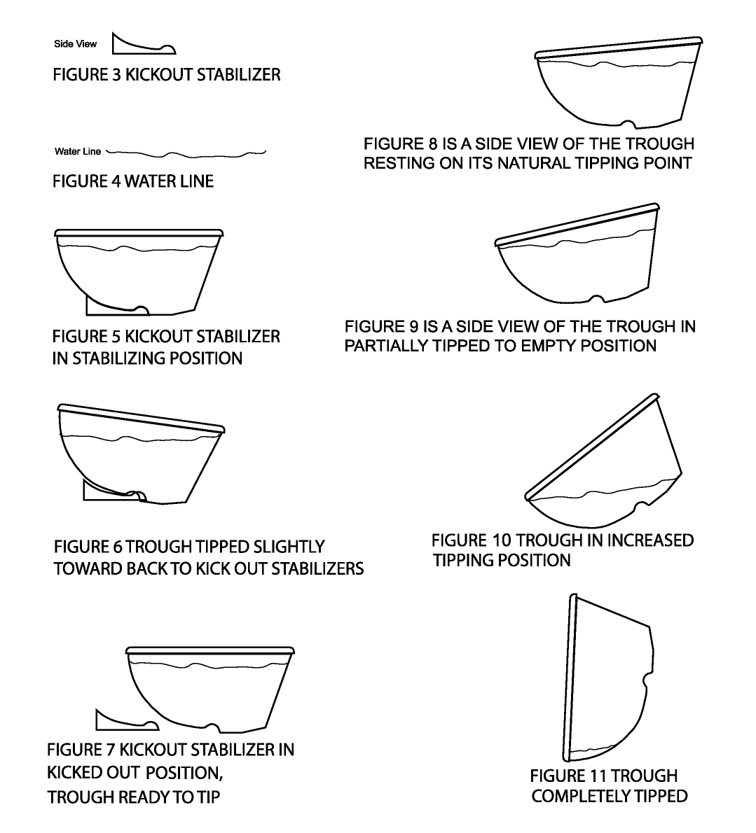

### DETAILED DESCRIPTION OF THE INVENTION

This invention is directed to troughs and more particularly to pre-cast or molded troughs made of plastic, fiberglass or other appropriate material and utilizing a novel shape whereby the trough rests on it's natural tipping point using a novel pair of stabilizers made to rest on the ground and fit into corresponding cavities on the underside of the trough to maintain an upright and stable position until tipping is desired.

What is claimed is:

1. A trough for holding heavy amounts of dry or liquid products comprising:
a molded body, the shape of which is such that the body rests on it's natural tipping point, it's underside including a recessed cavity for housing stabilizing device(s) shaped to fit into said recessed cavity that prevent tipping until and unless said stabilizing device(s) are removed.
said shape utilizing gravity to tip when desired,
said cavity extending the width of the trough,
said stabilizing device(s) being of the reverse shape of said cavity for fitting into said cavity until removed for tipping.

2. A trough, comprising; according to claim 1, a recessed cavity in said trough's underside and a shape whereby said trough rests securely at said trough's tipping point with the aid of stabilizing device(s).
A trough, comprising; according to claim 1, removable stabilizer device(s) shaped to fit into said recessed cavity preventing said trough from tipping while in desired resting position.
A trough, comprising; according to claim 1, said removable stabilizer device(s) which when removed allows said trough to tip.

3. A tub, comprising; according to claim 2, a recessed cavity in said tub's underside and a shape whereby said tub rests securely at said tub's tipping point with the aid of stabilizing device(s).
A tub, comprising; according to claim 2, removable stabilizer device(s) shaped to fit into said-recessed cavity preventing said trough from tipping while in desired resting position.
A tub, comprising; according to claim 2, said removable stabilizer device(s) which when removed allows said tub to tip.

4. A trough, comprising; a shape which rests on said troughs natural tipping point with the aid of stabilizing device(s) which is easily tipped by one person acting alone for the purpose of emptying contents when said stabilizing device(s) are removed.

5. A trough, comprising; according to claim 4, stabilizing device(s) for holding said trough in upright position for the prevention of spillage.

6. A trough, comprising; according to claim 4 a shape which is easily tipped by one person acting alone for the purpose of emptying the contents of the trough.

7. A trough, comprising; a stabilizing device(s) that can be put in place by one person acting alone, for holding said trough in upright position for the prevention of spillage.

8. A trough, comprising; according to claim 7, a shape which is easily tipped by one person acting alone for the purpose of cleaning the interior of said trough.

9. A trough, comprising; according to claim 7, a shape which is easily tipped by one person acting alone for the purpose of cleaning algae in the interior of said trough.

10. A trough, comprising; according to claim 7, a shape which is easily tipped by one person acting alone for the purpose of moving said trough.

11. A trough, comprising; according to claim 7 a shape which is easily tipped by one person acting alone for the purpose of removing ice from the interior of said trough.
